(19) United States
(12) Patent Application Publication
(10) Pub. No.: US 2008/0041841 A1
(43) Pub. Date: Feb. 21, 2008

(54) Piping with heater and connecting method of the piping

(75) Inventors: Yasuhiro Tanaka, Ageo-shi (JP); Atsushi Izumi, Nabari-shi (JP); Akinobu Tsuda, Nabari-shi (JP)

Correspondence Address: MCDERMOTT WILL & EMERY LLP, 18191 VON KARMAN AVE., SUITE 500, IRVINE, CA, 92612-7108, US

(73) Assignees: Nissan Diesel Motor Co., LTD.; Nitta Moore Company

(21) Appl. No.: 11/498,126

(22) Filed: Aug. 3, 2006

(51) Int. Cl. H05B 3/58

(52) U.S. Cl. 219/535

(57) ABSTRACT

A heater-attached piping having, a cord-like heater disposed along substantially entire length of a nylon tube forming a pipe for transferring a fluid, and at least a heat-retaining layer disposed around the nylon tube and the cord-like heater. The cord-like heater located at the end of the nylon tube may be, for example, folded back and formed in a duplex arrangement. With this arrangement, heat generating at the end of the heater-attached piping increases and is duplicated to result in suppression of power consumption of the cord-like heater to a possible lowest limit, and the heat-retaining ability and defrosting ability in the end of the heater-attached piping can be enhanced.

### BACKGROUND OF THE INVENTION

1. Field of the Invention

The present invention relates to a piping with a heater attached thereto (hereinunder, wholly refer to as “heater-attached piping” throughout the specification and the appended claims) through which various fluid is transferred, and more particularly, to a technique for enhancing heat-retaining ability and defrosting ability in a piping end.

2. Description of the Related Art

There are a variety of home and industrial equipment and devices having piping connected thereto for allowing a fluid or liquid substance to flow therethrough. If there occurs condensation or freeze in an interior of the piping in, for example, water supply equipment, a gas analyzer or the like used in cold climates, such condensation or freeze will cause inconvenience and trouble with the equipment and apparatuses. Thus, a heater-attached piping is employed as shown in Japanese Unexamined PatentApplication Nos. 2003-27535 and 2002-246157. In the heater-attached piping according to the known art is provided with a configuration disposing a cord-like heater and a lead wire along a pipe, and sequentially arranging a heat-equalizing layer, a heat-retaining layer, a binding layer and a protective covering around the pipe.

When the piping is connected to various devices or the like, at least the heat-retaining layer, the binding layer and the protective covering located at the end of the piping must be removed, in order to expose the piping end. Therefore, heat generated by the cord-like heater is radiated to the periphery of the piping end, and the heat-retaining ability and the defrosting ability at the piping end are inferior to those at a central portion of the piping. To compensate for heat loss due to heat-radiation from the piping end, it might be possible to contrive increasing of the heater capacity over the entire length of the piping. Nevertheless, in the case of a piping to be installed in a vehicle, since the capacities of a generator and a battery are limited, the increasing of the heater capacity has not been applicable.

Hence, with a view to solving the above-described conventional drawback, an object of the present invention is to provide a heater-attached piping in which a heater located at a piping end is formed in a multi-ply arrangement to increase local heat generation, so that power consumption of the heater is suppressed to the lowest possible limit, and uniform heat-retaining ability and defrosting ability can be exhibited over the entire length of the piping.

Another object of the invention is to provide a connecting method of such a heater-attached piping.

### SUMMARY OF THE INVENTION

In accordance with the present invention, there is provided a heater-attached piping which comprises a piping through which fluid is transferred, a cord-like heater disposed along a substantially entire length of the piping, and a heat retaining-layer disposed around the piping and the heater, wherein a predetermined length portion of the heater located at an end of the piping is formed in a multi-ply arrangement by folding back the end thereof or connecting the cord-like heater to the end thereof.

Preferably, a heat-equalizing-layer for substantially equally transmitting heat generated by the heater to an outer periphery of the piping is interposed between first and second sections, the first section having the piping and the heater, and the second section having the heat-retaining layer.

According to the described heater-attached piping, the end of the piping is configured to be heated by the predetermined length portion of the heater disposed along the substantially entire length of the piping through which fluid is transferred, which portion is formed in the multi-ply arrangement. Therefore, the amount of heat generating in that predetermined length portion when an identical electric current is supplied can be increased to bring about such advantages that the power consumption of the heater may be suppressed to the lowest possible limit, and the heat-retaining ability as well as defrosting ability at the piping end may be enhanced. At this stage, if the predetermined length of the heater to be formed into multi-ply arrangement is appropriately set in compliance with the heater capacity, supplied current and the like parameters, it is possible to exhibit substantially equal heat-retaining ability and defrosting ability over substantially the entire length of the heater-attached piping, and to effectively retain heat of the transferred fluid and to unfreeze the fluid to be transferred.

In accordance with another aspect of the present invention, there is also provided a connecting method of a heater-attached piping to a mating device, the heater-attached piping including a piping through which fluid is transferred, a cord-like heater disposed along substantially entire length of the piping, and at least a heat-retaining layer disposed around the piping and the heater, the connecting method being characterized in that the heat-retaining layer is firstly peeled off from the end so that portions of the piping and the heater are exposed, the piping end is then connected to the mating device, the exposed heater is thereafter formed into a multi-ply arrangement, the heat-retaining layer is further disposed around the exposed piping and heater, and the periphery of the heat-retaining layer is eventually coated with a heat-shrinkable tube. At this time, preferably, in addition to the heat-retaining layer disposed around the exposed piping and heater, a heat-equalizing layer is further disposed.

According to this connecting method, the heat-retaining layer located at the end is peeled off, portions of the piping and heater are exposed, the mating device is connected to the piping end and then, the exposed heater is formed into the multi-ply arrangement, the heat-retaining layer is disposed around the exposed piping and heater, and the periphery of the heat-retaining layer is coated with the heat-shrinkable tube. These series of operations are carried out in a predetermined sequence, thereby connecting the heater-attached piping to the mating device. Thus, it becomes easy to realize the heater-attached piping of the present invention using the existing heater-attached piping available from the market, and resultantly, curtailment of production cost and so on can be effected.

If the heat-equalizing layer is disposed, heat generated by the heater is substantially equally transmitted to the outer periphery of the piping through the heat-equalizing layer, the interior of the piping is substantially equally heated from its outer periphery, the temperature distribution of fluid to be transferred becomes substantially equal, and frozen fluid can be unfrozen in a short time.

Other objects, features and advantages of the present invention will become more apparent from the following description with reference to the accompanying drawings.

### BRIEF DESCRIPTION OF THE DRAWINGS

FIG. 1 is a block diagram of a heater-attached piping of the present invention applied to an exhaust gas purification device;

FIG. 2 is a front sectional view showing details of the heater-attached piping;

FIG. 3 is a side sectional view showing details of the heater-attached piping;

FIG. 4 is a diagram used for explaining a method for folding a cord-like heater in a piping end into a duplex structure;

FIG. 5 is a diagram used for explaining a method for making the cord-like heater in the piping end into a duplex structure using a crimp contact;

FIG. 6 is a diagram used for explaining a first step showing a connecting method of the heater-attached piping;

FIG. 7 is a diagram used for explaining a second step showing the connecting method of the heater-attached piping;

FIG. 8 is a diagram used for explaining a third step showing the connecting method of the heater-attached piping;

FIG. 9 is a diagram used for explaining a fourth step showing the connecting method of the heater-attached piping; and

FIG. 10 is a diagram used for explaining a fifth step showing the connecting method of the heater-attached piping.

### DESCRIPTION OF THE PREFERRED EMBODIMENT

The present invention will be explained in detail with reference to the accompanying drawings below.

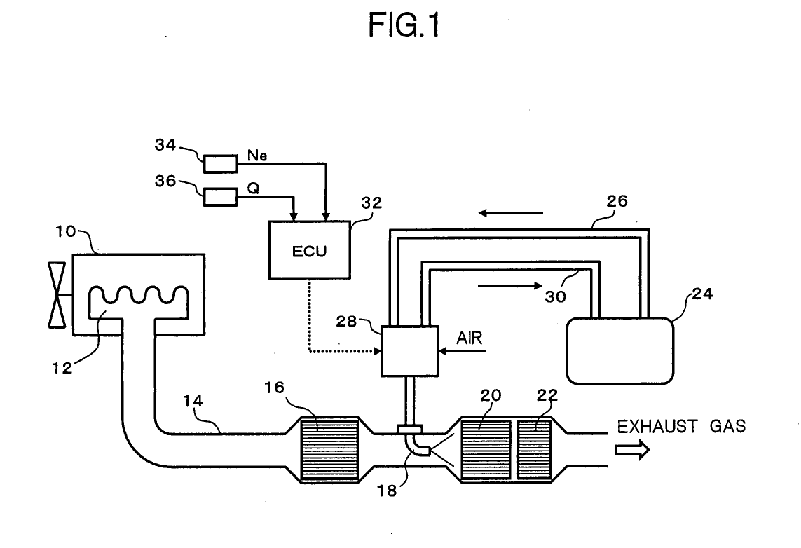

FIG. 1 shows an embodiment of a heater-attached piping according to the present invention applied to an exhaust gas purification device. In the exhaust gas purification device, urea aqueous solution is used as a reducing agent precursor, and nitrogen oxide (NOx) in engine exhaust is purified by catalytic reduction reaction.

An exhaust pipe 14 is connected to an exhaust manifold 12 of an engine 10. The following members are disposed in the exhaust pipe 14 along a flowing direction of exhaust gas, i.e., an oxidation catalytic converter 16 for oxidizing nitric oxide (NO) into nitrogen dioxide (NO₂), an injection nozzle 18 for injecting and supplying a necessary amount of urea aqueous solution suitable for an operation state of an engine, a NOx reduction catalytic converter 20 for reducing and purifying NOx by ammonia obtained by hydrolyzing the urea aqueous solution, and an ammonia oxidation catalytic converter 22 for oxidizing ammonia which has passed through the NOx reduction catalytic converter 20. The urea aqueous solution stored in a storage tank 24 is supplied to the injection nozzle 18 through a heater-attached piping 26 and a reducing agent supply device 28 in a mist state in which the urea aqueous solution is mixed with air. Excessive portion of the urea aqueous solution supplied to the reducing agent supply device 28 is returned into the storage tank 24 through a heater-attached piping 30. Here, the reason why the storage tank 24 and the reducing agent supply device 28 are connected to each other through the heater-attached pipings 26 and 30 is that the freezing point (ice point) of the urea aqueous solution is about −11° C. (about 262K), and when a vehicle runs on, for example, an area under cold climates or the cold latitudes, there might occur such an adverse possibility that urea aqueous solution supplied to the reducing agent supply device 28 from the storage tank 24 is frozen on its way to the reducing agent supply device 28 and as a result, NOx purifying ability might not be provided or be deteriorated due to lack of a reducing agent. It is preferable that the heater-attached piping 26 and 30 are controlled such that their heaters are appropriately operated in accordance with e.g., the outside temperature or the temperature in the storage tank 24.

A control unit 32 incorporating a computer is provided as a control system of the exhaust gas purification device. The control unit 32 controls an injection supply amount of the urea aqueous solution in accordance with the operation state of the engine. In the control unit 32, the reducing agent supply device 28 is controlled by a control program stored in a ROM (Read Only Memory) based on a signal from a rotating speed sensor 34 which detects engine rotating speed Ne and a load sensor 36 which detects engine load Q. As the engine load Q, it is possible to utilize a fuel injection amount, an inlet flow, an inlet negative pressure, an accelerator opening, a throttle valve opening and the like.

In such an exhaust gas purification device, the urea aqueous solution injected and supplied from the injection nozzle 18 is hydrolyzed by exhaust gas heat and water vapor in the exhaust gas, and ammonia is generated therefrom. It is known that the generated ammonia reacts with NOx in the exhaust gas, in the NOx reduction catalytic converter 20, and the ammonia is purified into water and harmless gas. To enhance the NOx purifying rate by the NOx reduction catalytic converter 20, NO is oxidized into NO₂ by the oxidation catalytic converter 16, and the rate between NO and NO₂ in the exhaust gas is improved to a rate suitable for the catalytic reduction reaction. The ammonia having passed through the NOx reduction catalytic converter 20 is oxidized by the ammonia oxidation catalytic converter 22 disposed downstream of exhaust gas, and thus, it is possible to prevent ammonia from being discharged into atmosphere.

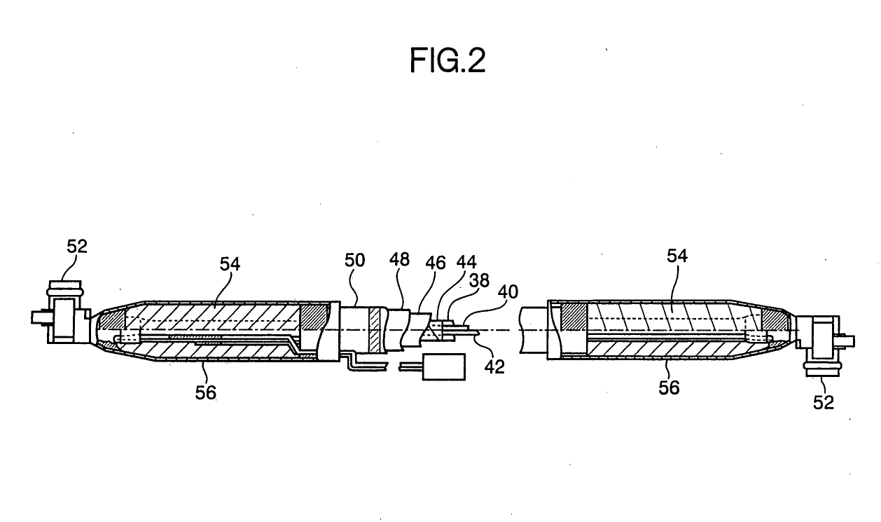

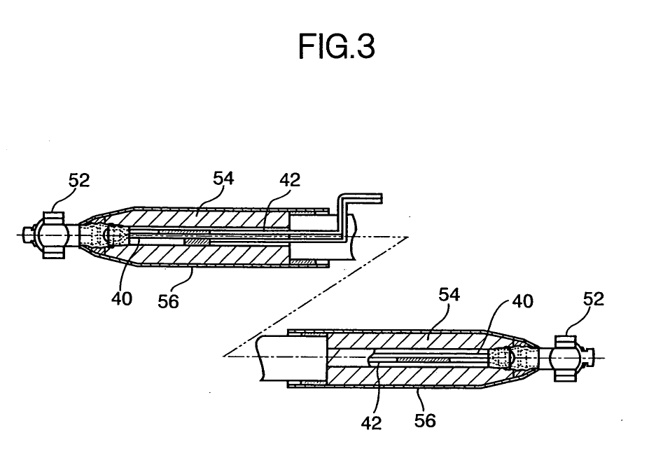

As shown in FIGS. 2 and 3, a cord-like heater 40 and a lead wire 42 are respectively disposed in the heater-attached piping 26 and 30 along substantially the entire length of a nylon tube or pipe 38 through which urea aqueous solution as a fluid is transferred, and a heat-equalizing layer 44 made of aluminum or the like heat transmittable material, a heat-retaining layer 46 comprised of glass fiber or the like heat-retainable material, a vapor barrier 48 made of polyester or the like humidity-resistant material, and a protecting cover 50 made of polyvinyl chloride or the like durable material are sequentially disposed around an intermediate portions thereof. The heat-equalizing layer 44 exhibits a function for substantially equally transmitting heat generated in the cord-like heater 40 to an outer periphery of the nylon tube 38. A tube through which urea aqueous solution is transferred is not limited to the nylon tube 38, and a resin fluoride tube may be used for arranging piping.

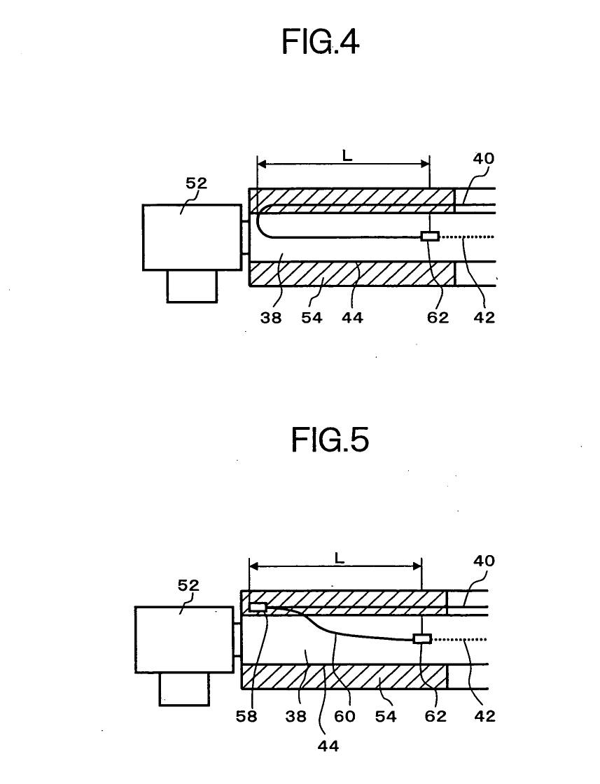

Terminal heat-retaining materials 54 are disposed around both ends of the nylon tube 38 as a heat-retaining layer made of substantially cylindrical silicon sponge or the like, instead of the heat-retaining layer 46, the vapor barrier 48 and the protecting cover 50 which are peeled off when a connector 52 as a mating device is connected. The terminal heat-retaining material 54 is coated with a heat-shrinkable tube 56 over substantially entire length thereof. A predetermined length portion of the cord-like heater 40, which is located between the nylon tube 38 and the terminal heat-retaining material 54, is arranged such that the heat-generative cord is disposed in a duplicated fashion to partially enable a duplicate amount of heat generation. More specifically, a predetermined length L of the end of the cord-like heater 40 is folded back as shown in FIG. 4, or a cord-like heater 60 having a predetermined length L is connected to the end of the cord-like heater 40 using a crimp contact 58 as shown in FIG. 5, thereby forming the predetermined length portion in the duplicated or two-ply arrangement. Here, if the crimp contact 58 is used as shown in FIG. 5, even if the softness of the cord-like heater 40 is low and it can not be folded back, the present invention can be applied. A crimp contact 62 located at substantially central portion in the drawing is for connecting the cord-like heater 40 and the lead wire 42 with each other. The end of the cord-like heater 40 need not be formed into the two-ply arrangement, and may be folded back many times into a multi-ply arrangement.

With this configuration, since the cord-like heater 40 is formed into the two-ply arrangement at the ends of the heater-attached pipings 26 and 30, heat generation is increased by about two times at that portion when the same amount of current is supplied, power consumption of the cord-like heater 40 is suppressed to a possible lowest limit, and the heat-retaining ability and defrosting ability at the end can be enhanced. If the predetermined length L to be formed into the two-ply arrangement is appropriately set in accordance with the heater capacity of the cord-like heater 40 and supplied current, it is possible to exhibit substantially equal heat-retaining ability and defrosting ability over substantially the entire length of the heater-attached piping, and it is possible to effectively retain heat and unfreeze the urea aqueous solution transferred through the piping comprised of the nylon tube 38.

Next, an explanation will be provided as to a procedure for connecting the connector 52 provided as an example of the mating device to the end of the heater-attached piping whose end is left cut, and the heat-equalizing layer 44, the heat-retaining layer 46, the vapor barrier 48 and the protecting cover 50 are sequentially disposed around the cord-like heater 40 and the lead wire 42 disposed along substantially the entire length of the nylon tube 38.

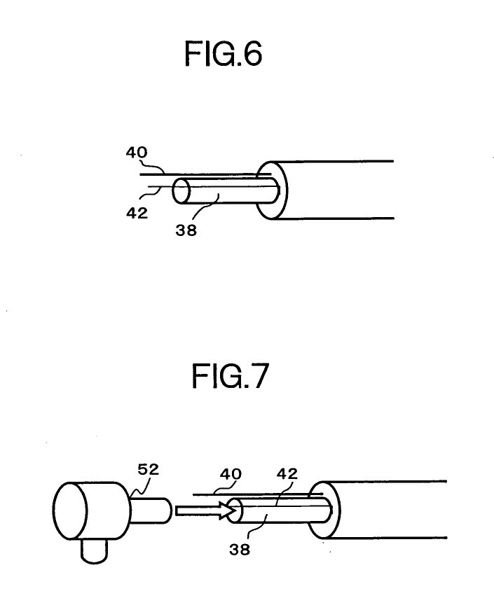

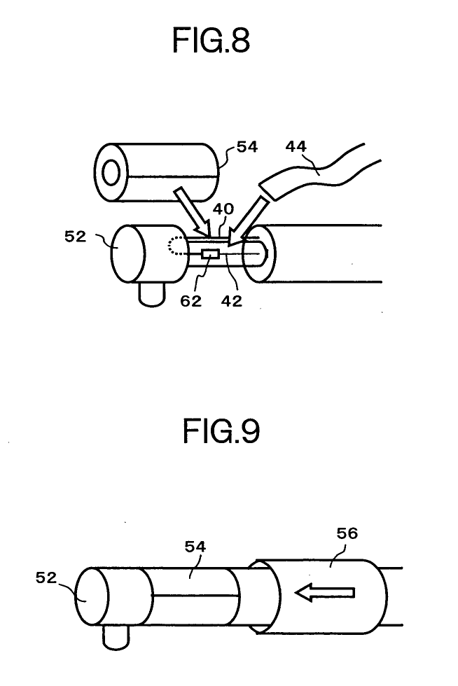

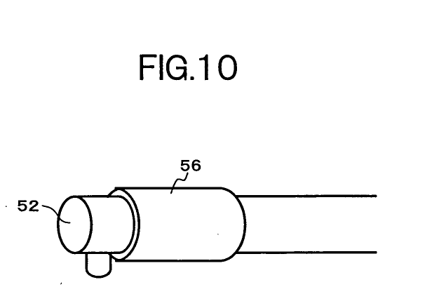

First, the protecting cover 50, the vapor barrier 48, the heat-retaining layer 46 and the heat-equalizing layer 44 are slit at appropriate positions from the end of the heater-attached piping, they are peeled off from the end as shown in FIG. 6, and the nylon tube 38, the cord-like heater 40 and the lead wire 42 are exposed. Then, the nylon tube 38 is grasped using a tool (not shown), and the connector 52 is press fitted to the end as shown in FIG. 7. After the connector 52 is press fitted to the end of the nylon tube 38, the predetermined length L of the exposed cord-like heater 40 is folded back and formed in a duplicate or two-ply arrangement as shown in FIG. 8, and the end and the lead wire 42 are connected to each other through the crimp contact 62. Then, the heat-equalizing layer 44 made of aluminum tape or the like material is wound around outer peripheries of the nylon tube 38 and the cord-like heater 40, and the substantially cylindrical terminal heat-retaining material 54 formed with slit in the axial direction is mounted on. After the terminal heat-retaining material 54 is mounted, the heat-shrinkable tube 56 is put over substantially entire length of the terminal heat-retaining material 54 as shown in FIG. 9 and then, this is heated and shrunk, and a periphery of the terminal heat-retaining material 54 is coated as shown in FIG. 10.

Accordingly, the protecting cover 50, the vapor barrier 48, the heat-retaining layer 46 and the heat-equalizing layer 44 which are located at the end are peeled off, the connector 52 is connected to the heater-attached piping, the cord-like heater 40 is formed into the duplex structure, the terminal heat-retaining material 54 is mounted, and its periphery is coated with the heat-shrinkable tube 56. These series of operations are sequentially carried out, and the heater-attached piping is connected to the mating device. Thus, it becomes easy to realize the heater-attached piping of the present invention using the general heater-attached piping, and producing cost can be reduced.

The heater-attached piping of the present invention is not limited to the exhaust gas purification device provided in a vehicle, and can be applied to water supply equipment and a gas analyzer in cold climate, of course.

We claim:

1. A heater-attached piping comprising:
a piping through which fluid is transferred;
a cord-like heater disposed along substantially an entire length of the piping; and
a heat-retaining layer disposed around the piping and the heater, wherein
a predetermined length portion of the heater located at an end of the piping is formed in a multi-ply arrangement.

2. The heater-attached piping according to claim 1, wherein the cord-like heater is formed in the multi-ply arrangement by folding back the end thereof.

3. The heater-attached piping according to claim 1, wherein the cord-like heater is formed in the multi-ply arrangement by connecting a different cord-like heater to the end of the first-said cord-like heater.

4. The heater-attached piping according to claim 1, wherein a heat-equalizing layer capable of substantially equally transmitting heat generated by the heater to an outer periphery of the piping is interposed between a first section and a second section, the first section having the piping and the heater, and the second section having the heat-retaining layer.

5. A method of connecting a heater-attached piping to a mating device, the heater-attached piping including a piping for transferring a fluid, a cord-like heater disposed along substantially entire length of the piping, and at least a heat-retaining layer disposed around the piping and the heater, comprising the steps of:
peeling off the heat-retaining layer from the end of the heater-attached piping upon connection of the heater-attached piping to said mating device;
subjecting portions of the piping and the heater to an uncoated state thereof exposed to the exterior;
connecting the piping end to the mating device;
forming the exposed heater at the piping end in a multi-ply arrangement;
disposing a heat-retaining layer around the exposed piping and heater; and
coating the periphery of the heat-retaining layer with a heat-shrinkable tube.

6. A method of connecting a heater-attached piping to a mating device, the heater-attached piping including a piping for transferring a fluid, a cord-like heater disposed along substantially entire length of the heater, and at least a heat-retaining layer disposed around the piping and the heater, comprising the steps of:
peeling off the heat-retaining layer from the end of the heater-attached piping upon connection of the heater-attached piping to said mating device;
subjecting portions of the piping and the heater to an uncoated state thereof exposed to the exterior;
connecting the piping end to the mating device;
forming the exposed heater at the piping end in a multi-ply arrangement;
disposing a heat-equalizing layer and the heat-retaining layer around the exposed piping and heater; and
coating the periphery of the heat-retaining layer with a heat-shrinkable tube.
